(19) United States
(12) Patent Application Publication
(10) Pub. No.: US 2008/0031013 A1
(43) Pub. Date: Feb. 7, 2008

(54) QUICK ASSEMBLY LIGHT

(76) Inventors: Patrick H. Ruggles, Solon, OH (US); James Hampshire, Twinsburg, OH (US)

Correspondence Address: HAHN LOESER & PARKS, LLP, One GOJO Plaza, Suite 300, AKRON, OH, 44311-1076, US

(21) Appl. No.: 11/686,703

(22) Filed: Mar. 15, 2007

Related U.S. Application Data
(60) Provisional application No. 60/784,072, filed on Mar. 17, 2006.

(51) Int. Cl. F21S 8/00

(52) U.S. Cl. 362/649; 362/647; 362/656

(57) ABSTRACT

A light fixture includes components that can be quickly assembled and disassembled. The fixture components have interlocking parts that allow an operator to snap or twist the components into locking engagement quickly and easily. Similarly, disassembly is just as easy. The components may also include decorated structural elements.

This utility patent application claims priority to U.S. provisional patent application Ser. 60/784,072 filed on Mar. 17, 2006, which is incorporated herein by reference in its entirety.

### TECHNICAL FIELD

The present invention pertains to lighting fixtures, and more specifically, to quick assembly lighting fixtures having a plurality of frame portions with extended tabs that interlock to hold the fixture together

### BACKGROUND OF THE INVENTION

There are many different kinds of lighting fixtures including both indoor and outdoor lighting fixtures. A fixture generally includes a framework onto which the electrical components of the light are typically mounted. Electrical receptacles may be installed into the fixture and the fixture mounted in a specific location to achieve the desired illuminating effect. In some instances the fixture is fashioned with an aesthetically pleasing design to create a certain ambience. Once assembled the lighting fixture can be hung from a ceiling or mounted to a wall.

One aspect of lighting fixtures pertains to the assembly of the lighting fixture. The lighting fixture may be cumbersome to assemble and likewise disassemble for repair or replacement of the fixture components. Fasteners or adhesives can be utilized to connect the components together requiring additional labor to complete the assembly process. It would be advantageous to have a lighting fixture that quickly interlocks to hold the fixture components in place.

### BRIEF SUMMARY

One embodiment of present invention includes a light fixture having a first light fixture housing section with one or more tabs. The first light fixture housing section includes an electrical receptacle, which may be an electrical socket, adapted to receive an associated lighting element. One or more electrical conductors may be connected to deliver electrical power to the light fixture and more specifically to the electrical receptacle. The fixture may include a second light fixture housing section having a peripheral edge adapted to interlock with the one or more tabs.

In one aspect of the embodiments of the present invention, the first light fixture housing section is snapped into interlocking engagement with the second light fixture housing section. Alternatively, the first light fixture housing section may be rotated into interlocking engagement with the second light fixture housing section.

Another aspect of the embodiments of the present invention includes a first light fixture housing section that is generally concave where the one or more tabs extend inwardly from the first light fixture housing section. The peripheral edge may include a lip extending outwardly around the periphery of the second light fixture housing section having one or more recesses for receiving the one or more tabs.

In yet another aspect of the embodiments of the present invention the second light fixture housing section may comprise a globe having one or more transparent panels for allowing light emanating from the lighting element to shine through the second light fixture housing section.

Another embodiment of the present invention includes a light fixture housing having a first housing section adapted to receive an associated electrical receptacle for illuminating an associated lighting element wherein the first housing section includes a first connecting portion. The light fixture housing may also include a second housing section that is adapted to overlay the associated lighting element and may further include a second connecting portion. The first and second connecting portions may be disposed relative to each other such that when the first housing section is juxtaposed to the second housing sections, the first and second connectors interlock to fasten the first and second housing sections together.

In one aspect of the embodiments of the present invention the housing sections may be molded from a thermoplastic material or polymer via injection molding or any other type of plastic molding chosen with sound judgment. Accordingly, the one or more tabs may be integrally molded into the first housing section. In this manner, the one or more tabs may be flexible and may snap into engagement with the second connecting portion.

### BRIEF DESCRIPTION OF THE DRAWINGS

FIG. 1 is a perspective view of a quick assembly light including electrical receptacles, in accordance with various aspects of the present invention.

FIG. 2 is a perspective view of a quick assembly light fixture, in accordance with various aspects of the present invention.

### DETAILED DESCRIPTION OF THE INVENTION

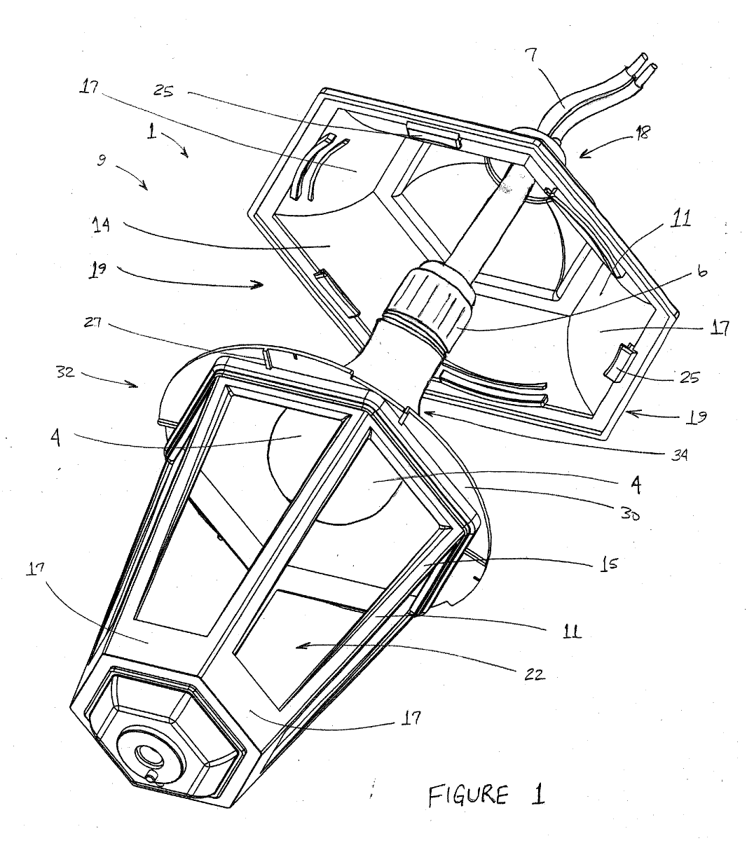

Referring now to the drawings wherein the showings are for purposes of illustrating embodiments of the invention only and not for purposes of limiting the same, FIG. 1 shows a lighting fixture depicted generally at 1. The lighting fixture 1 maybe an indoor or an outdoor lighting fixture 1 that includes an illuminating device such as a light bulb 4. The light bulb 4 may be a standard incandescent light bulb or a fluorescent light bulb. In fact, any type of illuminating device may be utilized without departing from the novel aspects of the subject invention. The lighting fixture 1 may further include an electrical receptacle 6 having conductors 7 electrically communicated thereto for providing power to illuminate the bulb 4. A substantially rigid frame, shown generally at 9, may form an internal cavity into which the bulb 4 and receptacle 6 may reside. The frame 9 may be fashioned by joining separate frame members 11 as will be discussed in detail below. The lighting fixture 1 may also include mounting brackets, not shown, that function to provide a means for an installer to affix the lighting fixture 1 to a wall, lamp post or any other structure onto which is suitable for mounting a lighting fixture 1. In one embodiment, the lighting fixture 1 may be hung by a chain from the top of the lighting fixture 1. Alternatively, the lighting fixture 1 may be fastened to a wall via brackets extending from the side or bottom of the lighting fixture 1. Still any manner of mounting the lighting fixture 1 to a structural support may be chosen with sound engineering judgment.

With continued reference to FIG. 1, the material that the lighting fixture 1 is constructed from may be plastic or another type of polymer-based substance. The plastic may be resistant to corrosion and to breakage for use in outdoor or other harsh environments. It is noted here that any type of materials and process may be used to construct the frame 9 of the lighting fixture 1 including but not limited steel, metal, wood or the like. The frame 9 may be finished with a coating such as paint and decorated to any extent desired as is appropriate for a lighting fixture 1.

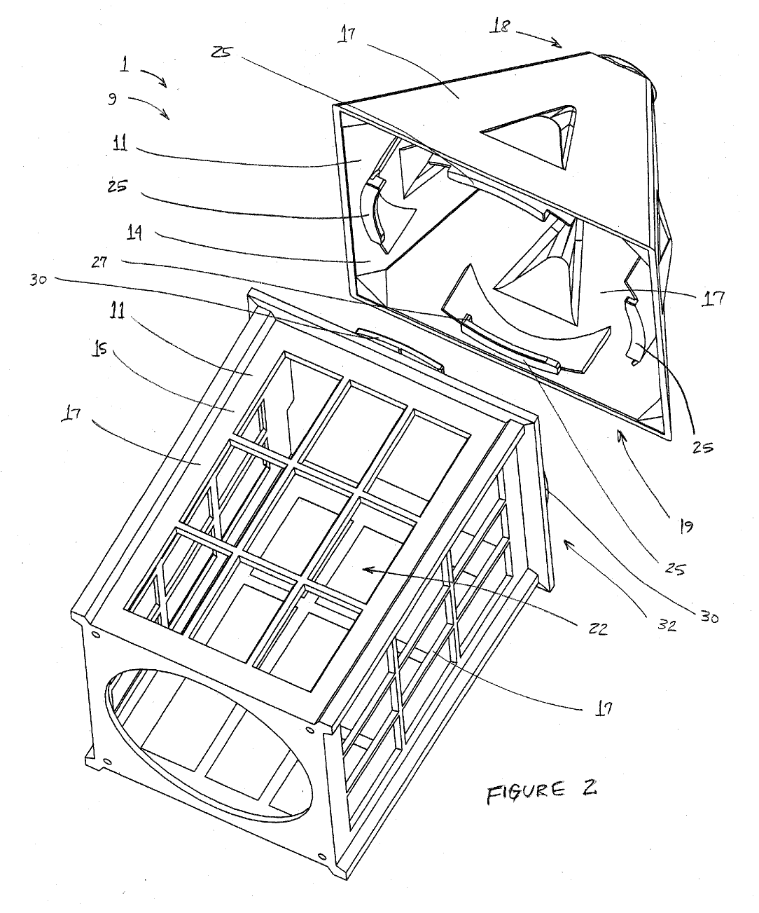

With reference again to FIG. 1 and also to FIG. 2, the lighting fixture 1 may be comprised of two separate frame members 14, 15 respectively, also termed light fixture housing sections. In one embodiment, the frame member 14 may be a top frame member 14 or first light fixture housing section 14. Similarly, the frame member 15 may be a bottom frame member 15 or second light fixture housing section 15. In this manner, the frame members 14, 15 may make up the entire frame 9. However, it is noted that any number of frame members may be utilized to make up the frame 9 of the lighting fixture 1 as is appropriate for use with the subject invention. Each of the frame members 14, 15 may include walls 17 that make the frame members substantially rigid. Specifically, the top frame member 14 may have a generally concave configuration. The first end 18 of the top frame member 14 may form an apex and the distal end 19 of the top frame member 14 may be open to connect to the bottom frame member 15. The bottom frame member 15 may have one or more walls that are contiguously formed or joined together to form an interior region 22 of the bottom frame member 15. In FIG. 1, the bottom frame member 15 is shown having a conical shape. In FIG. 2, the bottom frame member 15 has a rectangular cross section. Any configuration of top and bottom frame member 14, 15 may be chosen with sound engineering judgment. The top and bottom frame members 14, 15 when connected together form an enclosed area that may encompass or envelop the receptacle 6 and light bulb 4. Accordingly, the volume of space of contained within the two frame members 14, may be sufficient for the receptacle 6 and bulb 4 to reside therein. It is noted here that while the present embodiment depicts a single light bulb, the present invention may be utilized in conjunction with any number of light bulbs and receptacles. The receptacle 6 may be mounted to the top frame member 14. In one embodiment, the receptacle 6 may be removeably connected to the top frame member 14. By removeably connected it is meant that the receptacle 6 may be attached to or removed from the walls 17 via fasteners or other retaining means.

With reference again to FIGS. 1 and 2, as mentioned above the top and bottom frame members 14, 15 may be assembled together to form the lighting fixture 1. In one embodiment, this may be accomplished by fashioning a tab 25 extending from an interior wall 17 of the top frame member 14. The tab 25 may form an angle with an interior side of the wall 17. The tab 25 may extend substantially horizontal with respect to when the lighting fixture 1 is mounted in place. However, any angle may be chosen by which to extend the tab 25 from the side of the wall 17. The tab 25 may further include a tab stop 27 that engages a lip 30 fashioned in the bottom frame member 15 to be discussed below. The tab stop 27 may extend substantially perpendicular to the tab 25 so that the lip 30 abuts the tab stop 27 when the top and bottom frame members 14, 15 are joined together. As alluded to, the bottom frame member 15 may have a lip 30 that extends radially from an end 32 of the bottom frame member 15. The lip 30 may span a relatively small portion of the perimeter bottom frame member 15 as shown in FIG. 2. Alternatively, the lip 30 may traverse substantially around the entire perimeter of the bottom frame member 15 as shown in FIG. 1. In this instance, a recess 34 may be formed in the lip 30 to allow the tab 25 to fit over prior to twisting the frame members 14, 15 together. In this way, the top and bottom frame members 14, 15 may be quickly connected together simply by juxtaposing the members 14, 15 together and rotating one member with respect to the other. The present embodiments show multiple tabs and lips. FIG. 1 shows three tab-lip pairs, while FIG. 4 shows 4 tab-lip pairs. The tabs 25 may be spaced equidistantly apart around the periphery of the open end of the top frame member 14. Likewise, the lips 30 may also be equidistantly spaced so as to correspond in position to the tabs 25. This provides for a quick and secure fitting together of the lighting fixture components.

With reference to all of the FIGURES, assembly of the lighting fixture 1 will now be discussed. To assemble the lighting fixture 1, an assembly person may juxtapose the top frame member 14 to the bottom frame member 15 such the tab 25 is proximate to the lip 30. In the embodiment shown in FIG. 2, the top frame member 14 may be positioned offset with respect to the bottom frame member 15, inserted onto the bottom frame member 15 and rotated together thereby engaging the lip 30 with the tab 25 until the tab stop 27 inhibits further movement. In FIG. 1, the tabs 25 may be inserted through the recesses 34 respectively and under the lip 30. Subsequently, the top frame member 14 is then rotated with respect to the bottom frame member 15 until the tabs 25 abut the tab stops 27. It is noted in this embodiment, that the tab stops 27 are fashioned extending from the underside of the lip 30.

The invention has been described with reference to a preferred embodiment. Obviously, modifications and alterations will occur to others upon a reading and understanding of this specification. It is intended to include all such modifications and alternations in so far as they come within the scope of the appended claims or the equivalence thereof.

I/We Claim:

1. A light fixture, comprising:
a first light fixture housing section having one or more tabs;
an electrical receptacle adapted to receive an associated lighting element, the electrical receptacle being operatively connected to the light fixture;
one or more electrical conductors electrically communicated to the electrical receptacle; and,
a second light fixture housing section having a peripheral edge adapted to interlock with the one or more tabs.

2. The light fixture as defined in claim 1, wherein the first light fixture housing section is snapped into interlocking engagement with the second light fixture housing section.

3. The light fixture as defined in claim 1, wherein the first light fixture housing section is rotated into interlocking engagement with the second light fixture housing section.

4. The light fixture as defined in claim 3, wherein the first light fixture housing section is generally concave, and,
wherein the one or more tabs extend inwardly from the first light fixture housing section.

5. The light fixture as defined in claim 4, wherein the peripheral edge includes a lip extending outwardly around the periphery of the second light fixture housing section, the lip having one or more recesses for receiving the one or more tabs.

6. The light fixture as defined in claim 1, wherein the electrical receptacle is operatively attached to the first light fixture housing section.

7. The light fixture as defined in claim 6, wherein the second light fixture housing section overlays the associated lighting element.

8. The light fixture as defined in claim 7, wherein the second light fixture housing section comprises a globe.

9. The light fixture as defined in claim 1, further comprising:
means for mounting the light fixture to an associated structure.

10. The light fixture as defined in claim 9, wherein said means for mounting includes a chain for hanging the light fixture on the associated structure.

11. The light fixture as defined in claim 1, further comprising:
one or more tab stops for restricting movement of the first light fixture housing section relative to the second light fixture housing section.

12. A light fixture housing, comprising:
a first housing section adapted to receive an associated electrical receptacle for illuminating an associated lighting element, the first housing section having a first connecting portion;
a second housing section adapted to overlay the associated lighting element, the second housing section having a second connecting portion; and,
wherein the first and second connecting portions are disposed relative to each other such that when the first housing section is juxtaposed to the second housing sections the first and second connectors interlock to fasten the first and second housing sections together.

13. The light fixture housing as defined in claim 12, wherein the first connecting portion comprises one or more tabs that interlock with the second connecting portion.

14. The light fixture housing as defined in claim 13, further comprising:
one or more tab stops for restricting movement of the first housing section relative to the second housing section.

15. The light fixture housing as defined in claim 14, wherein the one or more tabs are integrally molded into the first housing section.

16. The light fixture housing as defined in claim 12, wherein each of the first and second housing sections are generally concave, and,
wherein the assembled first and second housing sections form an enclosure for envelops the associated electrical receptacle and the associated lighting element.

17. The light fixture housing as defined in claim 12, wherein the first housing section is constructed from weather resistant material.

18. The light fixture housing as defined in claim 17, wherein the first housing section is constructed from a thermoplastic material.

19. The light fixture housing as defined in claim 17, wherein the second housing section includes one or more transparent panes.

20. The light fixture housing as defined in claim 12, further comprising:
a bracket for mounting the light fixture housing onto an associated structure.
